(19) United States
(12) Patent Application Publication
(10) Pub. No.: US 2009/0147862 A1
(43) Pub. Date: Jun. 11, 2009

(54) Semiconductor Device and IC Card Having The Same

(75) Inventor: Shigeo Ohyama, Nara-shi Nara (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 11/909,921

(22) PCT Filed: Mar. 23, 2006
(86) PCT No.: PCT/JP2006/305859

§ 371 Date: Sep. 27, 2007

(30) Foreign Application Priority Data
Mar. 30, 2005 (JP) 2005-099781

(51) Int. Cl. H04B 3/00

(52) U.S. Cl. 375/257

(57) ABSTRACT

An IC card (1) includes: a plurality of circuit blocks (11 to 14); and an internal bus (21) which allows the circuit blocks to be connected to one another. Out of the circuit blocks, a CPU block (11) on an output side includes an encoding circuit (41) for outputting data to be transferred to a signal line (21a) of the data bus (22) after encoding the data in accordance with a predetermined encoding method so that variation of the data is evener, and a coprocessor block (12) on an input side includes a decoding circuit (42) for decoding the encoded data transferred via the signal line (21a). As a result, it is possible to realize (i) a semiconductor device which includes the plural circuit blocks and the internal signal line which allows the circuit blocks to be connected to one another but can decrease a possibility that data transferred among the circuit blocks may be estimated by power consumption analysis and (ii) an IC card having the semiconductor device.

### TECHNICAL FIELD

The present invention relates to (i) a semiconductor device which can decrease a possibility that data transferred among circuit blocks via an internal signal line may be estimated by power consumption analysis and (ii) an IC card having the semiconductor device.

### BACKGROUND ART

An IC card internally includes a semiconductor device, whereby it is possible to carry out various kinds of operations such as a code processing, so that the IC card allows information to be stored therein with greater safety than a magnetic card. Thus, the IC card for a purpose which requires great safety, e.g., for a purpose of personal identification with stored secret information, is expected to be used more and more widely.

While, an offensive technique for intercepting internal information without accessing the inside of the IC card has been devised. With a focus on a condition under which power consumption varies according to a process carried out in an internal circuit, there was devised a technique in which a correlation between the internal process and the power consumption is grabbed and the power consumption is analyzed so as to estimate the internal process. Note that, typical examples of the offensive technique include SPA (Simple Power Analysis), DPA (Differential Power Analysis), and the like.

Unlike an offensive technique for physically accessing the inside of the IC card, each of the aforementioned offensive techniques requires no external process carried out with respect to the IC card, so that it is difficult for the IC card to detect any offensive process so as to prevent leakage of information.

Thus, for example, the below-described Patent Document 1 mentions an arrangement in which a coprocessor unit provided on a chip together with a CPU has a pointer by which it is possible to intentionally assign a storage region of an operation memory.

According to the arrangement, the coprocessor unit has the aforementioned pointer, so that it is possible to transfer data from one storage region to another storage region of the operation memory by changing a set value of the address pointer. Herein, a storage capacity of the operation memory is set so that plural groups of remainder operation data can be stored therein, so that predetermined operation data can be transferred from the operation memory to a remainder operation device in the coprocessor unit.

As a result, the coprocessor unit sequentially receives the operation data from an external RAM under control of the CPU, and the coprocessor unit can suppress the number of times operation results are periodically transferred to the external RAM under control of the CPU, thereby reducing external transfer of data which is carried out by the coprocessor unit. As a result, it is possible to reduce a time taken to transfer data, and it is possible to suppress data hacking carried out on the basis of analysis of a current waveform corresponding to the data transfer.

### [Patent Document I]

Japanese Unexamined Patent Publication 129033/2004 (Tokukai 2004-129033)(Publication date: Apr. 22, 2004)

### DISCLOSURE OF INVENTION

However, according to the conventional arrangement, the number of times the operation results are transferred is suppressed, but data is transferred via a bus between the CPU and the coprocessor unit when writing first data and an encryption key into the operation memory or when reading out the operation data after completion of the operation.

Thus, if power consumption at these times is analyzed, it is possible to estimate data transferred between the CPU and the coprocessor. Hence, greater safety is required.

The present invention was made in view of the foregoing problems, and an object of the present invention is to provide (i) a semiconductor device which includes a plurality of circuit blocks and an internal signal line which allows the circuit blocks to be connected to one another but can decrease a possibility that data transferred among the circuit blocks may be estimated by power consumption analysis and (ii) an IC card having the semiconductor device.

In order to solve the foregoing problems, a semiconductor device according to the present invention comprising: a plurality of circuit blocks; and an internal signal line which allows the circuit blocks to be connected to one another, wherein an output side circuit block out of the circuit blocks includes an encoding circuit for encoding data to be transferred in accordance with a predetermined encoding method so that variation of the data is evener and for outputting the data to the signal line, and an input side circuit block out of the circuit blocks includes a decoding circuit for decoding the data, having been encoded, which is transferred via the signal line.

According to the arrangement, in transferring the data among the circuit blocks via the signal line, the data is transferred after the data is encoded by the encoding circuit. Thus, the encoded data, i.e., data whose variation is evener than the original data is transferred to the signal line.

In case of transferring data among the circuit blocks via the signal line, a capacity of the signal line is larger than a case of transferring data within a circuit block, so that it is necessary to drive the signal line by a circuit having a greater driving ability. This results in greater power consumption at the time of a change of data transferred through the signal line. Thus, according to an arrangement in which data is transferred to the signal line without any modification, power consumption of the semiconductor device varies depending on the data. As a result, even if the semiconductor device is arranged so that it is impossible to directly access the signal line, it is possible to carry out an offence for estimating data flowing through the signal line by analyzing the power consumption of the semiconductor device.

However, according to the aforementioned arrangement, data whose variation is evener than the original data is transferred, so that the power consumption of the semiconductor device is less dependent on the data. As a result, it is possible to decrease a possibility that data transferred among the circuit blocks may be estimated by the power consumption analysis.

Note that, according to the arrangement, the decoding circuit is provided on the input side circuit block, so that the input side circuit block grasps data having not been encoded (original data) without any trouble and allows the data to be transferred among the circuit blocks without any trouble even though the output side circuit block outputs encoded data.

Further, the semiconductor device may be arranged so that the encoding circuit carries out Manchester encoding with respect to the data to be transferred and outputs the data having been subjected to the Manchester encoding. Further, the semiconductor device may be arranged so that the encoding circuit includes a logic circuit for carrying out an exclusive-OR operation between the data to be transferred and a clock signal or for carrying out a NOT operation thereof. Further, the semiconductor device may be arranged so that the decoding circuit includes a logic circuit for carrying out an exclusive-OR operation between a data signal from the signal line and a clock signal synchronous with that clock signal or for carrying out a NOT operation thereof.

According to the arrangement, 1-bit data is subjected to Manchester encoding so that “0” is encoded into “01” and “1” is encoded into “10”. Thus, a signal necessarily varies in each data bit, so that variation of the power consumption is evener. As a result, it is possible to decrease a possibility that data transferred among the circuit blocks may be estimated by the power consumption analysis.

Further, the encoding circuit for carrying out the Manchester encoding can be realized by the aforementioned logic circuit, so that it is possible to realize the encoding circuit which does not consume a clock cycle and whose circuit arrangement is simple. Further, the decoding circuit can be realized by the aforementioned logic circuit, so that it is not necessary to be synchronous with the encoded data unlike a circuit which becomes synchronous with the encoded data by means of a PLL circuit or the like. Thus, it is possible to omit a synchronization detection circuit. As a result, the decoding circuit can be realized by a relatively simple circuit arrangement.

Further, the semiconductor device may be arranged so that one of the input side circuit block and the output side circuit block is a central operation block and the other of the input side circuit block and the output side circuit block is a coprocessor block for carrying out an encryption operation.

It is often that important data, e.g., a parameter for encoding or data to be processed, is transferred between the central operation device block and the coprocessor block for carrying out the encryption operation. If the data is estimated by a third party, the third party can intercept the encoded data or can wickedly manufacture a semiconductor device which can execute the same process as the foregoing semiconductor device, so that the third party can make believe that the third party is a regular user.

However, the foregoing arrangement allows for decrease of a possibility that data transferred between the central operation device block and the coprocessor may be estimated by the power consumption analysis. As a result, it is possible to decrease a possibility that the encoded data may be unwillingly intercepted and a possibility that the third party may make believe that the third party is the regular user.

Further, the semiconductor device may be arranged so that the signal line constitutes a bus which allows the circuit blocks to be bus-connected to each other.

In an arrangement in which the signal line is bus-connected, it is possible to reduce the number of signal lines used to connect the circuit blocks, but a larger load is likely to be exerted to each signal line. Thus, if data is outputted to the signal line without any modification, the power consumption more greatly varies depending on the data. As a result, according to the arrangement, it is easy to estimate the data by the power consumption analysis.

However, according to the aforementioned arrangement, data flowing through the signal line is encoded, so that it is possible to decrease a possibility that data transferred among the circuit blocks may be estimated by the power consumption analysis though the circuit blocks are bus-connected to one another.

Further, the semiconductor device may be arranged so that the output side circuit block includes a driving circuit, constituted of a complementary circuit, which drives the signal line.

In case where the driving circuit constituted of the complementary circuit drives the signal line, it is possible to obtain a relatively high driving current with a relatively simple circuit arrangement, but power is consumed more due to a through current of the complementary circuit when the data flowing in the signal line varies. Thus, if the data is outputted to the signal line without any modification, the power consumption more greatly varies depending on the data. As a result, it is easy to estimate the data by the power consumption analysis in the arrangement.

However, according to the aforementioned arrangement, the data flowing in the signal line is encoded, so that it is possible to decrease a possibility that data transferred among the circuit blocks may be estimated by the power consumption analysis though the output side circuit block includes the driving circuit constituted of the complementary circuit.

Further, in order to solve the foregoing problems, an IC card according to the present invention includes any one of the aforementioned semiconductor devices. The semiconductor device arranged in the foregoing manner can decrease a possibility that data transferred among the circuit blocks may be estimated by the power consumption analysis. Thus, it is possible to realize an IC card having greater safety.

In this way, according to the present invention, data is transferred after being encoded so that variation of the data is evener than that of original data, thereby causing the power consumption of the semiconductor device to be less dependent on the data. Thus, it is possible to decrease a possibility that data transferred among the circuit blocks may be estimated by the power consumption analysis. As a result, the semiconductor device can be widely and favorably used as a semiconductor device used for various purposes of use, e.g., for an IC card.

### BRIEF DESCRIPTION OF DRAWINGS

FIG. 1, showing an embodiment of the present invention, is a circuit diagram illustrating essential portions in a vicinity of a data bus of an IC card.

FIG. 2 is a block diagram illustrating essential portions of the IC card.

FIG. 3 is a waveform diagram illustrating signal waveforms in respective portions of the IC card.

FIG. 4, showing a comparative example, is a circuit diagram illustrating essential portions in a vicinity of a data bus arranged by deleting an encoding circuit and a decoding circuit from the IC card.

FIG. 5 is a waveform diagram illustrating how a waveform of a signal transferred in the data bus and power consumption in the IC card vary with time passage.

FIG. 6 is a waveform diagram illustrating how a waveform of a signal transferred in the data bus and power consumption in the IC card vary with time passage.

FIG. 7 is a flow chart illustrating how a coprocessor block provided in the IC card operates.

### BEST MODE FOR CARRYING OUT THE INVENTION

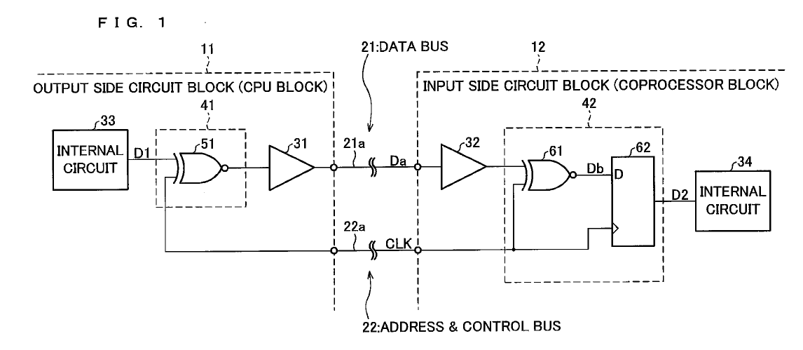

The following describes an embodiment of the present invention with reference to FIG. 1 to FIG. 7. That is, a semiconductor device according to the present embodiment causes power consumption to be less dependent on data, so that the semiconductor device can be favorably used as a device which carries out an encryption process or a decryption process for example. Note that, examples of a device including the foregoing device are various devices such as an IC card, but the following describes a case where the device is the IC card for example.

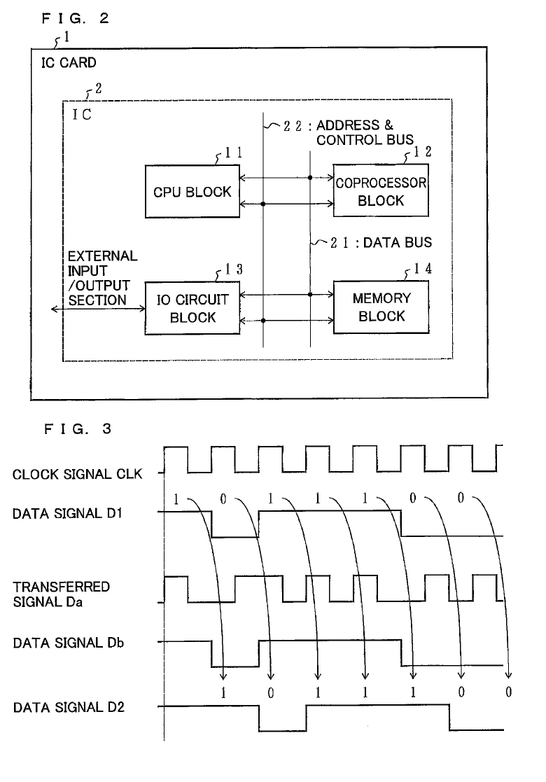

That is, as illustrated in FIG. 2, an IC card 1 according to the present embodiment includes an IC (integrated circuit) 2 serving as a semiconductor device, and the IC 2 has: a plurality of circuit blocks 11 to 14; a data bus 21, serving as a bus for connecting these circuit blocks to one another, through which a data signal is transferred; and an address & control bus 22 for transferring an address signal and a control signal.

In an example shown by FIG. 2, as the circuit blocks, there are provided: a CPU (central processing unit) block 11 for entirely controlling the IC 2; a coprocessor block 12 for carrying out a predetermined standard process such as numerical value operation and encryption or an encoding process; an IO circuit block 13 for controlling input and output from and to the outside of the IC card 1; and a memory block 14 into and from which data is written and read out by these blocks 11 to 13 via the buses 21 and 22. Further, the CPU block 11 can write and read out the data into and from the coprocessor 12 and the IO circuit block 13 via the buses 21 and 22. For example, it is possible to carry out the following processes: a process such as encryption operation is started; the coprocessor block 12 is instructed to carry out the process by writing into the coprocessor block 12 data required in the process (e.g., parameters or a process target); input and output are started; parameters required in the input and output (e.g., an address range of data which should be inputted or outputted) are written into the IO circuit block 13 so as to give an instruction to input or output data into or from the IO circuit block 13. Note that, in case where the process carried out by the coprocessor block 12 is an encryption operation, examples of the data include key data, plaintext, and the like. Further, examples of the data read out after the process include an encrypted text having been encoded, and the like.

Further, the IC card 1 is equipped with, as the memory block 14, a memory circuit whose data is broken upon coming into contact with air for example, or the IC card 1 is equipped with a circuit for detecting connection of an ordinarily unused terminal such as a probe and breaking data thereof for example, thereby preventing access into the IC card 1.

Further, in the coprocessor block 12, algorithm of the operation process is set so that the power consumption and the internal process are less correlated to each other. For example, the coprocessor block 12 is equipped with a pointer by which a storage region of the operation memory can be intentionally specified (these members are not shown). In the arrangement, the coprocessor block 12 has the pointer, so that data can be transferred from one storage region to another storage region of the operation memory by changing a set value of the address pointer. Further, a storage capacity of the operation memory is set so that a plurality of groups of remainder operation data can be stored therein. As a result, predetermined operation data can be transferred from the operation memory to the remainder operation device in the coprocessor block 12.

Thus, the CPU block 11 causes the coprocessor block 12 to sequentially receive the operation data from the external memory block 14, and the CPU block 11 causes the coprocessor block 12 to less frequently carry out periodical transfer of the operation result to the external memory block 14, thereby reducing the number of times the coprocessor block 12 externally transfers data. As a result, it is possible to reduce a time taken to transfer data while preventing data hacking based on analysis of a current waveform at the time of data transfer.

As to data transfer among the circuit blocks 11 to 14, a transfer distance is longer than that of data transfer in each of the circuit blocks 11 to 14. Thus, a greater load is exerted to the signal line through which data is transferred. Therefore, as illustrated in FIG. 1, an output buffer circuit (driving circuit) 31 serving as an output device or an input buffer circuit 32 serving as an input device are provided between each of internal circuits of the circuit blocks 11 to 14 and each signal line (the buses 21 and 22 or the like). Note that, the output buffer circuit 31 is provided between the output side circuit block (the CPU block 11 in this figure) out of the circuit blocks 11 to 14, more specifically, the internal circuit 33 for outputting data and the signal line constituting the buses 21 and 22 (e.g., the signal line 21a). Further, the input buffer circuit 32 is provided between the input side circuit block (the coprocessor block 12 in this figure), more specifically, the signal line constituting the busses 21 and 22 (e.g., the signal line 21a) and the internal circuit 34.

An output stage of the output buffer circuit 31 includes, for example, a complementary circuit such as a CMOS-structure circuit or a complementary emitter-follower circuit and the like. A driving ability of the output buffer circuit 31 is set to be so high as to be enough to transfer data via the signal line 21a compared with driving abilities of the internal circuits 33 and 34. Further, as to the circuit arrangement of the input buffer circuit 32, data is transferred via the signal line 21a, so that a time constant or the like is set so as to correctly discriminate a value even if the signal has a blunt waveform.

As a result, even though each of distances among the circuit blocks 11 to 14 is longer than a distance between the internal circuits, the circuit blocks 11 to 14 can transfer data without any trouble.

Note that, in the present embodiment, the circuit blocks 11 to 14 are bus-connected to one another, and all the circuit blocks 11 to 14 are connected to each signal line (21a or the like), so that a greater load is exerted to the signal line 21a than an arrangement in which the circuit blocks 11 to 14 are connected to signal lines respectively. Thus, also the driving ability of the output buffer circuit 31 is set to be higher than the case where the circuit blocks 11 to 14 are connected to signal lines respectively.

However, the output buffer circuit 31 and the input buffer circuit 32 are arranged in the foregoing manner, so that it is necessary to consume more power in case of transferring data among the circuit blocks 11 to 14 than the case of transferring data between the internal circuits of each of the circuit blocks 11 to 14. Further, as will be detailed in Comparative Example, if data which should be transferred is transferred through the signal line 21a without any modification, the power consumption varies depending on the transferred data.

However, the IC card 1 according to the present embodiment includes an encoding circuit 41, provided between the internal circuit 33 on the output side and the signal line 21a of the data bus 21 (between the internal circuit 33 and the output buffer circuit 31 in this figure), which carries out an encoding process in accordance with such an encoding method that variation of data (bit number corresponding to the data variation) is evener (more preferably, the data variation is even). Further, between the signal line 21a and the internal circuit 34 on the input side (between the input buffer circuit 32 and the internal circuit 34 in this figure), a decoding circuit 42 for decoding the data having been encoded by the encoding circuit 41 is provided.

The present embodiment adopts, as the encoding method, the Manchester encoding method using a clock signal for example. The encoding circuit 41 is realized by an XNOR circuit 51 which carries out a NO operation of exclusive-OR between data D1 and a clock signal CLK from the internal circuit 33 so as to output the operation result to the output buffer circuit 31. As a result, encoding data Da is transferred through the signal line 21a of the data bus 21 instead of the data D1.

Further, the decoding circuit 42 includes: an XNOR circuit 61 which carries out a NO operation of exclusive-OR between the data Da and a clock signal CLK from the input buffer circuit 32 so as to output the operation result; and a latch circuit 62 for latching an output Db of the XNOR circuit 61 at a timing indicated by the clock signal CLK. In the present embodiment, the latch circuit 62 is realized by a D-FF (flip-flop) and latches the output Db at a timing when the clock signal CLK rises.

According to the arrangement, in case where the output side internal circuit 33 is to transfer the data D1 (for example, 1, 0, 1, 1, 1, 0, 0) as illustrated in FIG. 3, the encoding circuit 41 encodes the data D1 into the data Da in accordance with the aforementioned circuit arrangement. As a result, the data Da having been encoded is outputted through the signal line 21a of the data bus 21. While, as illustrated in FIG. 3, the XNOR circuit 61 of the decoding circuit 42 decodes the data Da so as to generate the data Db, and the latch circuit 62 adjusts a waveform of the data Db and causes a timing thereof to correspond to the clock signal CLK. As a result, the decoding circuit 42 outputs a data signal D2 (1, 0, 1, 1, 1, 0, 0 in this example) whose content, except for delay in a phase by a single clock, is identical to that of the data D1 the internal circuit 33 is to transfer. Note that, in this figure, delay caused by the circuits 41 and 42 and transfer delay in the signal line 21a are not shown for convenience in description.

Thus, the data Da different from the data D1 is transferred to the signal line 21a, but the data D2 (=D1) the output side internal circuit 33 is to transfer is inputted to the input side internal circuit 34. As a result, the data D1 (=D2) is correctly transferred from the internal circuit 33 to the internal circuit 34.

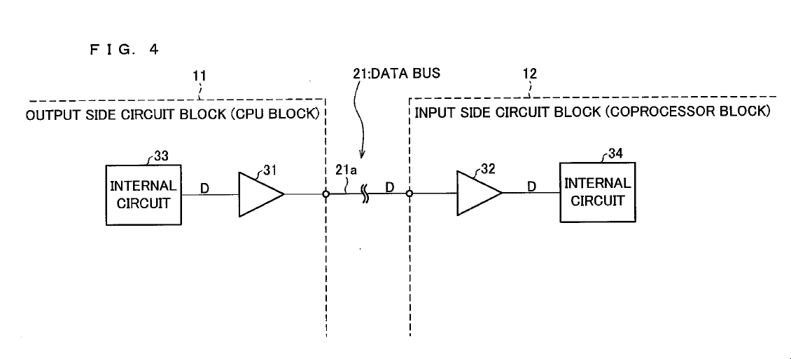

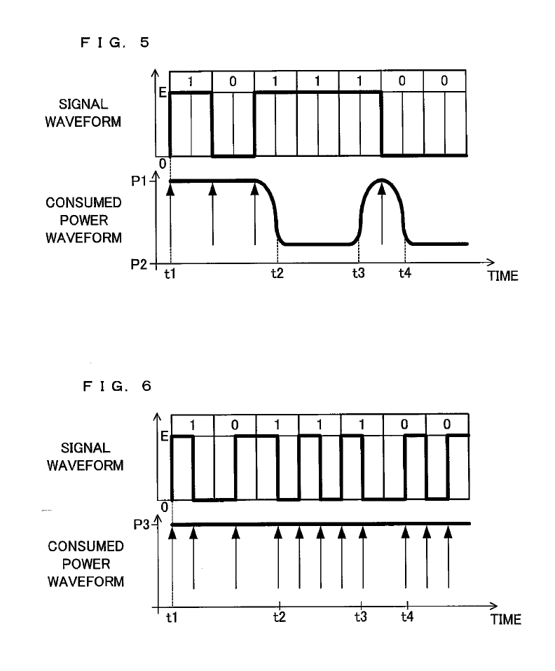

The following describes a comparative example. According to the arrangement in which the encoding circuit 41 and the decoding circuit 42 are omitted as illustrated in FIG. 4, the data D to be transferred is transferred to the signal line 21a without any modification as illustrated in FIG. 5, so that the power consumption of the IC card 1 varies depending on the data D to be transferred.

More specifically, the data D to be transferred varies during periods t1 and t2 and periods t3 and t4, so that power consumption of both the buffer circuits 31 and 32 is kept at a relatively high level, and also power consumption of the IC card 1 is accordingly kept at a relatively high level P1. While, the data D to be transferred does not vary during periods t2 and t3, so that power consumption of both the buffer circuits 31 and 32 is suppressed to a relatively low level, and also the power consumption of the IC card 1 is accordingly kept at a relatively low level P2.

As a result, the data bus 21 is provided in the IC card 1, and the IC card 1 does not allow the data bus 21 to be directly accessed from the outside, but the power consumption of the IC card 1 varies depending on the data D as described above, so that there is a possibility that the data D transferred through the data bus 21 may be estimated by analyzing the power consumption of the IC card 1.

However, in the present embodiment, the encoding circuit 41 and the decoding circuit 42 are provided, so that the data Da having been encoded frequently varies regardless of a value of the data D1 and regardless of whether the data D1 varies or not and the data D1 necessarily varies at least once in a clock cycle as illustrated in FIG. 3.

Thus, the same data D1 (=D) as in FIG. 5 is transferred between the internal circuits 33 and 34, but power consumption of both the buffer circuits 31 and 32 is always kept at substantially a constant level, and also power consumption of the IC card 1 is accordingly kept at substantially a constant level P3.

For example, the power consumption P1 during the periods t1 and t2 and during the periods t3 and t4 is different from the power consumption P2 during the periods t2 and t3 in FIG. 5, but the data Da varies also during the periods t2 and t3 in the present embodiment. Thus, as illustrated in FIG. 6, the power consumption of the IC card 1 is kept at a relatively high level also during periods t2 and t3, and the power consumption of the IC card 1 is fixed at substantially the constant level P3 during periods t1 to t4.

As a result, it is possible to cause the power consumption in transferring data to be less dependent on the data unlike the arrangement illustrated in FIG. 4, and this makes it difficult to grab a correlation between the consumed power waveform and the data, thereby making it difficult to estimate the data D1 by analyzing the power consumption of the IC card 1 (for example, by DPA or the like). As a result, it is possible to protect internal information from an offence for exposing an internal operation through the power consumption analysis, so that it is possible to realize the IC card 1 having greater safety.

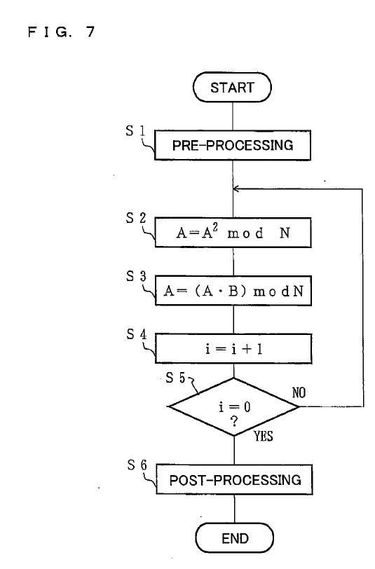

With reference to FIG. 7, the following describes an example of how the coprocessor block 12 carries out the encryption operation. Note that, examples of the encryption operation include an RSA encryption operation, a DES encryption operation, and the like. In the following description, a case where the coprocessor block 12 carries out the RSA encryption operation is explained as an example.

That is, in a step 1 (hereinafter, the step is referred to as S1, and other steps are referred to in a similar manner) illustrated in FIG. 7, as a pre-processing of the encryption operation, the coprocessor block 12 receives A, B, N, and i, as parameters for the encryption operation, from the CPU block 11 via the data bus 21, and stores them into a storage device such as a register (not shown).

Next, the coprocessor block 12 carries out operations of A=A² mod N, A=(A·B)mod N, i=i−1 in steps S2, S3, and S4, respectively. Further, in S5, the coprocessor block 12 determines whether i is 0 or not. Then, the processes carried out in S2 to S5 are repeated until i becomes 0 (repeated during a period corresponding to “NO” in S5).

While, when i becomes 0 (YES in S5), the coprocessor block 12 carries out a post processing of the encryption operation in S6, for example, by transmitting an operation result A via the data bus 21 to the CPU block 11 or by writing the operation result A into the memory block 14. In this manner, the coprocessor 12 can encrypt the received data.

However, in this case, A, B, N, and i are transferred through the data bus 21 as parameters for the encryption operation in S1. Thus, if these data are estimated by the aforementioned power consumption analysis, even when the IC card 1 outputs encrypted data to the outside, there is a possibility that not a regular communicating end but a third party may estimate the original data (plaintext). Further, if the parameters are clarified, it is possible to produce a fake IC card whose response is identical to that of the IC card 1, so that the third party can make believe that the third party is a regular user of the IC card 1 by using the fake IC card instead of the IC card 1.

However, according to the arrangement of the present embodiment, it is possible to prevent the parameters from being estimated by the power consumption analysis. As a result, it is possible to prevent the plaintext from being estimated (intercepted) by the third party and it is possible to prevent the third party from making believe that the third party is the regular user, thereby realizing the IC card having greater safety.

Note that, the foregoing description explained the case where the encoding circuit 41 and the decoding circuit 42 are equipped with the XNOR circuits 51 and 61 respectively as logic circuits each of which carries out a NO operation of exclusive-OR. However, it is possible to obtain the same effect also by providing, instead of the circuits 51 and 61, an XNOR circuit which inverts an output logic of each circuit so as to output exclusive-OR.

Further, the foregoing description explained, as an example, the case where the coprocessor block 12 is equipped with the pointer by which a storage region of the operation memory can be intentionally specified, but the present invention is not limited to this. The coprocessor block 12 may be arranged in any manner as long as the coprocessor block carries out the encryption operation. In this case, it is possible to suppress variation of the power consumption, which is caused by variation of data transferred among the circuit blocks, by carrying out the encoding process as described above. Thus, it is possible to obtain the same effect.

However, if the algorithm of the operation process in the coprocessor block 12 is set so that the power consumption and the internal process are less correlated to each other as in the present embodiment, it is possible to prevent not only variation of the power consumption which is caused by variation of data but also variation of the power consumption which is caused by variation of the internal process, thereby further enhancing the safety.

Further, the foregoing description explained, as an example, the case where the IC card 1 is arranged so as to prevent access into the IC card 1, but the present invention is not limited to this. The IC card 1 may be arranged in any manner as long as the IC card 1 is arranged so as to prevent access into the IC card 1 and the IC card 1 has tamper resistance. In this case, it is possible to prevent not only the offence carried out by the power consumption analysis but also an offence carried out by accessing the inside of the IC card 1, thereby further enhancing the safety.

Note that, the foregoing description explained, as an example, the case where the encoding circuit 41 carries out the Manchester encoding, but the present invention is not limited to this. For example, it is possible to adopt other encoding method such as a CM1 encoding method. Specifically, the encoding method is as follows: If data is 0, 0 is changed to 1, and if the data is 1, an encoding process is carried out so that output data is 0 or 1. The encoding method may be arranged in any manner as long as variation of data to be transferred is evener. In this case, it is possible to obtain the same effect.

In case of carrying out the Manchester encoding as in the present embodiment, a signal necessarily varies in each data bit, so that variation of the power consumption is evener. As a result, it is possible to further decrease a possibility that data transferred among the circuit blocks may be estimated by the power consumption analysis.

### INDUSTRIAL APPLICABILITY

According to the present invention, data is transferred after being encoded so that variation of the data is evener than original data, so that it is possible to cause power consumption of a semiconductor device to be less dependent on the data, thereby decreasing a possibility that the data transferred among the circuit blocks may be estimated by the power consumption analysis. As a result, it is possible to favorably use the semiconductor device for a wide variety of purposes such as an IC card.

1. A semiconductor device, comprising: a plurality of circuit blocks; and an internal signal line which allows the circuit blocks to be connected to one another, wherein
an output side circuit block out of the circuit blocks includes an encoding circuit for encoding data to be transferred in accordance with a predetermined encoding method so that variation of the data is evener and for outputting the data to the signal line, and
an input side circuit block out of the circuit blocks includes a decoding circuit for decoding the data, having been encoded, which is transferred via the signal line.

2. The semiconductor device as set forth in claim 1, wherein the encoding circuit carries out Manchester encoding with respect to the data to be transferred and outputs the data having been subjected to the Manchester encoding.

3. The semiconductor device as set forth in claim 2, wherein the encoding circuit includes a logic circuit for carrying out an exclusive-OR operation between the data to be transferred and a clock signal or for carrying out a NOT operation thereof.

4. The semiconductor device as set forth in claim 3, wherein the decoding circuit includes a logic circuit for carrying out an exclusive-OR operation between a data signal from the signal line and a clock signal synchronous with that clock signal or for carrying out a NOT operation thereof.

5. The semiconductor device as set forth in claim 1, wherein one of the input side circuit block and the output side circuit block is a central operation block and the other of the input side circuit block and the output side circuit block is a coprocessor block for carrying out an encryption operation.

6. The semiconductor device as set forth in claim 1, wherein the signal line constitutes a bus which allows the circuit blocks to be bus-connected to each other.

7. The semiconductor device as set forth in claim 1, wherein the output side circuit block includes a driving circuit, constituted of a complementary circuit, which drives the signal line.

8. An IC card, comprising a semiconductor device,
said semiconductor device including: a plurality of circuit blocks; and an internal signal line which allows the circuit blocks to be connected to one another, wherein
an output side circuit block out of the circuit blocks includes an encoding circuit for encoding data to be transferred in accordance with a predetermined encoding method so that variation of the data is evener and for outputting the data to the signal line, and
an input side circuit block out of the circuit blocks includes a decoding circuit for decoding the data, having been encoded, which is transferred via the signal line.
